(19) United States
(12) Patent Application Publication
(10) Pub. No.: US 2003/0169236 A1
(43) Pub. Date: Sep. 11, 2003

(54) Hand and wrist support

(76) Inventor: John Crocker, York (GB)

Correspondence Address: JACOBSON HOLMAN PLLC, 400 SEVENTH STREET N.W., SUITE 600, WASHINGTON, DC, 20004, US

(21) Appl. No.: 10/312,573

(22) PCT Filed: Jul. 13, 2001
(86) PCT No.: PCT/GB01/03107

(51) Int. Cl. G09G 5/00

(52) U.S. Cl. 345/168

(57) ABSTRACT

A hand and wrist support for a user of a computer keyboard, mouse or the like comprises a body member having associated with an upper surface an upper support means to engage the user's hand or wrist in use which upper support means comprises at least a pair of raised areas defining a central channel therebetween. The areas provide support to a users hand, and in particular respectively to the thenar muscles and the joint of the fourth metacarpal and the carpals to provide a through that runs parallel with the line of a user's median nerve. The device serves in particular as a comfort aid to a user of a computer, but might also have value as a prophylactic device for the prevention of carpal tunnel syndrome and median nerve compression syndrome, and/or as a therapeutic device for the treatment of carpal tunnel syndrome and median nerve compression syndrome arising from excessive computer use.

The invention relates to a hand and/or wrist support for use by users of computers and similar devices, and in particular for use by users of a computer mouse, to provide increased comfort and support to the hand and/or wrist, and in particular to inhibit or prevent or alleviate the symptoms of carpal tunnel syndrome and carpal tunnel syndrome-like symptoms.

Carpal tunnel syndrome has been recognised as a potential problem and an industrial disease in a range of working environments for some time. Classically, the problem tends to arise where an operator carries out a repetitive task involving repetitive flexion of the wrist. For example, the problem is known to exist amongst garment workers, users of hand tools and power tools and the like.

Conventionally, carpal tunnel syndrome has been attributed to pressure and/or friction damage on the median nerve as it passes through the carpal tunnel under the transverse carpal ligament or flexor retinaculum at the distal end of the wrist. The effects are at best debilitating, and can in severe cases require surgery to reduce the pressure on the median nerve.

Repetitive strain injury involving various symptoms, including symptoms akin to those exhibited by sufferers of carpal tunnel syndrome, has become an increasing problem in recent years in relation to users of computers. Prolonged use of a keyboard, mouse or similar device can lead to swelling and constriction of the carpal tunnel and the sufferer may notice weakness, pain, numbness or tingling in the fingers and thumb as well as bung pains and cramp in the wrist and forearm.

Some of these symptoms may well be the result of overuse as well as bad posture, arising not so much because of repeated flexion of the wrist, but rather at least in part by the performance of repetitive tasks with the wrist unnaturally bent. There has been an increasing realisation of the importance of keeping the wrists and forearms straight, both by attention to posture and by the provision of mechanical devices in the form of wrist supports.

There is also a growing suspicion that carpal tunnel syndrome-like symptoms in regular users of a computer keyboard and computer mouse are at least aggravated by, if not primarily caused by, direct pressure on the median nerve as the wrist or hand rests upon the desk top surface. In addition, holding a mouse whilst resting the hand on the edge of the desk can cause damage to the wrist. As a result, wrist supports have evolved which offer a degree of cushioning.

Examples of simple wrist rests of this type may be found, for example, in U.S. Pat. Nos. 5,131,614 and 5,228,655. Both of these documents describe a wrist rest support for supporting a user's wrist when performing such repetitive tasks as operating a computer keyboard or computer mouse. The support pad is primarily directed in each instance to assisting the user in keeping the wrist straight, but includes some degree of cushioning. More sophisticated cushionings have been developed, but the underlying principle remains the same.

Such devices have gained fairly widespread use in relation to keyboard users, but are not so practical for users of a computer mouse. Accordingly, UK patent application GB 2288454 A and International patent application WO 0004489 describe wrist support pads specifically designed for attachment to a computer mouse, to move with the mouse in use and to support the wrist into an elevated position, so that it is held generally horizontally.

All of these devices function in essentially the same way. Their primary purpose is to maintain the wrist horizontal and/or to cushion the area of the carpal tunnel. In each case however, although some cushioning may be provided, the heel of the hand and/or wrist still bears down on and is rested upon the support surface, so that the sensitive median nerve and associated ligaments in the carpal tunnel are still being pressurised.

Most wrist support devices are designed from soft material and spread the pressure across the entire wrist. However, it must be emphasised that they are not designed to keep pressure off the carpal tunnel area, and it is suspected that the use of such devices can in some cases worsen the symptoms. It is also relevant that it is becoming increasingly common to advise keyboard users specifically against using any form of wrist support whilst typing, the suggestion instead being that whilst typing the hand and wrists should be held straight and level with the keys and free of any surface.

In the alternative, it has been suggested that protective gloves might be used to prevent or alleviate carpal tunnel syndrome and other like symptoms in computer users. In the past, gloves have been used for protective purposes in industries where carpal tunnel syndrome has conventionally arisen (for example involving the repetitive use of tools). Gloves have also been used as part of a treatment regime for sufferers.

Prophylactic gloves have been suggested, for example in International patent application WO 9427528 in which a glove is described for the treatment and/or prevention of carpal tunnel syndrome. The glove is to be worn on the hand and wrist of a person and consists of a sleeve of elastic material which stretches longitudinally as well as transversely and is biased to hold the wrist at a preferred angle, thus serving both to hold the wrist at the preferred angle in a relaxed state and to limit excessive flexion. At a simpler level, elastomeric wrist straps have also been suggested.

Gloves and wrist straps have not achieved widespread use amongst computer users because of their evident lack of practicality. They are inconvenient, and are likely to inhibit and require removal for the performance of other office tasks. Accordingly, external supports for the wrist have gained much more widespread availability, despite the drawbacks that they do not necessarily successfully reduce damaging pressure on the median nerve.

It is an object of the present invention to provide a comfort support for supporting a user's hand and/or wrist when the user is performing tasks involving repetitive motions such as operating a computer keyboard or a computer mouse, offering potentially enhanced levels of comfort in relation to prior art systems.

It is a particular object of the invention to provide a comfort support which is particularly suited to users of a computer mouse.

It is a particular object of the invention to provide a comfort support which mitigates some or all of the disadvantages of prior art support in alleviating the symptoms of repetitive strain injury, and in particular carpal tunnel syndrome and like symptoms, in computer users.

Thus according to a first aspect of the present invention, a hand and wrist support for a user of a computer keyboard, mouse or the like comprises a body member having associated with an upper surface an upper support means to engage the user's hand or wrist in use which upper support means comprises at least a pair of raised areas defining a central channel or trough area therebetween.

Preferably, a pair of raised elements or paired series of raised elements are provided to constitute the pair of raised areas, this pair of raised areas being disposed to define a linear channel therebetween for example being generally parallel in orientation. In use, the device is positioned immediately under the transverse carpal ligament at the base of the hand, such that one raised area supports the soft tissue at the base of the thumb and in particular the thenar muscles and the other raised area supports the hand at the joint of the fourth metacarpal and the carpals. The two raised areas thus separate and define a trough area that runs parallel with the line of the user's median nerve in use.

The width of the gap constituted by the trough area between the two raised areas and the overall width of the device are selected to comfortably support an average hand while preventing the carpal tunnel area from touching the device at the trough between the raised areas. Devices with gaps of varying thickness may be provided for hands of different sizes, but wit the general constraint that the size must be such to support the hand such that the carpal tunnel area does not touch the device, size considerations are not critical.

The device offers potentially enhanced levels of comfort when used as a wrist support by a user of a computer keyboard or mouse or the like when compared with prior art devices which at best cushion the area of the median nerve. By contrast in the device according to the present invention, the median nerve and carpal tunnel area is supported clear of the primary support surfaces, so that any downward pressure on the hand and arm, for example in relation to the user's weight, is borne substantially or entirely on the soft tissue pads either side of the carpal tunnel and does not pressurise the carpal tunnel area itself to any significant degree.

Thus the device does not merely help to keep the wrists straight and provide some cushioning of the affected area, which is the best offered by any prior art device. Rather, the present invention relieves pressure on the median nerve itself and surrounding tissue and blood vessels, which is known to ease some of the symptoms of carpal tunnel syndrome and median nerve compression syndrome. The device is instead designed to support the hand in areas where there are few blood vessels, and where there is little delicate tissue which might be damaged by compression.

Whilst the invention is not limited by such medical considerations, the device may, ill addition to improving user comfort, have some prophylactic effects in that its use prior to the development of discomfort could prevent the increase of pressure on the carpal tunnel area and the onset of some discomfort symptoms. The device may also have a therapeutic effect in that it slightly spreads apart the bones of the wrist, thereby reducing the underlying pressure in the carpal tunnel and reducing the likelihood of injury requiring surgical intervention in the future.

The device offers advantages over gloves and wrist restraints in that it does not need to be removed to perform other tasks such as writing, drawing, typing, eating, drinking, using the telephone or washing the hands; it avoids the problems of perspiration which might be associated with some glove-type devices, and does not restrict the movement of the hand or fingers as would be the case with some tight-fitting elastic glove or wrist restraint devices.

Moreover, the same device can be used with either the left or the right hand.

The raised areas which together make up the supporting part of the upper support means may be incorporated with the upper surface of the body member in any convenient manner. For example, the whole of the upper support means may be integral with the body member. However, different material considerations will generally apply to the material behaviour of the body member and upper support means. Preferably, the body member will be manufactured of a substantially rigid material. Preferably in contrast at least the raised elements which support the hand will be manufactured from a material exhibiting a degree of flexible resilience to cushion the soft tissue of the hand when supported thereon.

In one embodiment, this is achieved using a single material construction in which the raised areas are treated to give the desired resilient cushioning. For example the raised areas have a thin walled structure defining one or more open cells, and the body has a substantially solid structure.

In an alternative embodiment, the raised elements constituting the raised areas of the upper support means are fabricated from flexibly resilient material. The raised areas may consist of raised elements applied to the upper surface of a generally rigid base member to define a gap disposed to lie generally parallel to the carpal tunnel of the user in use. Alternatively, an entire upper support means may be fabricated from flexibly resilient material, incorporating raised areas defining a trough area therebetween configured to lie generally parallel to the carpal tunnel of the user in use. The whole upper support means is then applied to the preferably generally rigid base member. Alternatively, a preferably generally rigid base member comprises a lower base portion and an upper top portion defining a cavity. The top portion is provided with holes through which a flexibly resilient material is able to protrude to make up the raised elements. For example, the base member may be fabricated as a two piece construction from a rigid base portion and a rigid top portion with flexibly resilient material sandwiched or otherwise retained therebetween and protruding through the holes in the top portion.

The raised elements constituting the raised areas of the upper support means may be fabricated from material which is inherently flexibly resilient, for example comprising a close cell foam pad or the like. Alternatively, in a particularly preferred embodiment, the raised areas constitute hollow convex structures such as domes of elastomeric or rubber-like material.

In use, substantially all of the downward pressure on the hand is supported by the upper support means in contact with the soft tissue at either side of the carpal tunnel. It is the purpose of the invention that relatively little pressure, if any, is exerted on the carpal tunnel area. In its simplest embodiment, this is achieved by providing an entirely open gap in the channel defined by the raised areas. However, the invention does not preclude the provision of further flexibly resilient material in the gap between the raised areas, provided such further material is of substantially reduced stiffness relative to the material of the raised areas, such that substantially all of the support pressure continues to be borne by the soft tissue at either side of the carpal tunnel in use. Similarly, the invention does not preclude the application of a cover layer covering the whole device and sitting supported upon the raised area, provided again that the material of the cover is resiliently deformable and of low stiffness such that substantially no pressure is exerted on the median nerve area in use.

Whilst a free gap is to be preferred from a technical view point to avoid exertion of pressure on the carpal tunnel area, the insertion of filler material in the gap and/or a cover thereover might be more desirable for other reasons, for example for ease of fabrication, hygiene or ease of cleaning, or for aesthetic or commercial considerations. Such a configuration may be countenanced within the general similar scope of the present invention provided the filler material and/or cover material are suitably selected to ensure that substantially all of the supporting pressure is still borne away from the carpal tunnel area in use.

Flexibly resilient material making up at least the raised areas may be of any suitable cushioning material, such as upholstered sponge or foam rubber, or resilient synthetic foam material. Preferably the material is washable. A preferred material is closed cell polyurethane foam. The padding may have a composite, multiple layer construction, for example consisting of an anti static fabric laminated to a foam or other base material.

Additionally or alternatively, the raised areas or the entire upper support means may be of a gel-impervious material, comprising a layer of resilient gel enclosing in a flexible, gel-impervious cover. Such an upper hand support means may comprise multiple raised elements, or may be shaped to provide suitably positioned raised areas by appropriately configuring the gel impervious container layer and/or by providing projections suitably arranged between the gel and the base element.

Additionally or alternatively the raised areas are hollow convex structures of elastomeric or rubber-like material. The domes are generally hollow to give resilience, but are preferably provided internally with structure support ribs for additional rigidity. These holes are provided within the structures to allow free air underneath and mean that the hand is not compressing or pumping air in use. In each case, designs and logos may be moulded in or printed on for advertising or promotional purposes.

For use with a computer mouse, in particular the device is preferably slideable on a desk top, mouse mat or other surface. Accordingly, in a preferred embodiment, the body member has associated with a lower surface means to reduce translational friction.

The means to reduce translation friction disposed on the lower surface of the base element may comprise a wheel, roller, ball or other rotational or like means. However, for mechanical simplicity, the means to reduce translation friction preferably comprises a low friction surface. The low friction surface may comprise the whole lower surface of the base member, or may comprise a lower surface of a projection therefrom. In either case, the lower surface is preferably generally rounded, domed or partly domed to a convex or partially convex profile and/or the outer edges of the base member or projection at the lower surface are rounded. This facilitates translational movement over discontinuities or obstructions on the desktop (e.g. across the edge of a mouse mat).

The low friction surface may be integral with the base member (in the sense that the whole base member is fabricated from a low friction material). Suitable materials, offering a combination of adequate rigidity for the base element with low friction in use might include nylon or acetal. In a particularly preferred embodiment, acetal is used for all of the rigid parts of the base member, such that the low friction surface is integrally formed as part of the lower surface of the base member, with the base member either formed as a single piece moulding or in several components. Raised support areas on the upper surface of flexibly resilient material may then be applied the alternative, the low friction surface may comprise a surface layer applied to the lower surface of the base member, or to the lower surface of a projection therefrom as the case may be. Alternatively, the low friction surface may comprise a low friction element, for example in the form of a plate-like attachment of low friction material, fixedly attached to the lower surface of the base member. The use of a low friction surface or low friction element in this way allows use of a higher friction material for the body element which can then be selected for other material properties. For example, HDPE, polypropylene or vinyl based mouldings could be used in conjunction with a low friction surface of PTFE, PTFCE, acetal or other suitable materials.

This embodiment of the invention is provided with a low friction base surface to allow freedom of movement in conjunction with a computer mouse. Accordingly, in a further preferred embodiment, mounting means are provided to couple the supporting device with a computer mouse. Preferably, the mounting means allow for ready releasable engagement of the device to the mouse to facilitate use of the device at a number of locations.

The mounting means should be so disposed and the raised areas so configured, that when the device is coupled to a mouse ill use, the users hand is supported such that he wrist is substantially un-flexed.

The mounting means preferably provides for releasable attachment of the device to a mouse. Suitable attaching means to achieve this include releasable snap fit connectors, and in particular articulated releasable snap fit connectors such as ball and socket joints. Additional or alternative mounting means include complementary felt loop and resilient hook pads, belt, buckle and strap fastenings, hook and eye couplings and the like.

The mounting means may provide for coupling of the mouse and support in a rigid relationship. However, for many applications it will be preferable if the mounting means are such as to permit limited relative movement between the support and the mouse when coupled. This will permit fine scale work to be carried out by making fine scale adjustments to the mouse without necessitating movement of the wrist.

To facilitate this, the mounting means may incorporate a flexible elongate coupling member, to extend between the support device and a mouse coupled to the support device in use so as to permit some relative movement therebetween. Alternatively, a coupling member may be provided with one or more rigid, relatively slidable portions, for example in the form of a telescoping rod and/or in the form of a rigid bar slidingly received within a cavity in a mounting housing, again in each case extending between the support device and a mouse coupled to the support device so as to permit some relative movement therebetween in use.

In one particularly preferred embodiment, the coupling comprises a sliding bar utilising a releasable attachment such as a ball and socket attachment for easy detachment and durability (by provision of a suitable snap-fit connection, it can be designed such that the snap-fit connection is released under stress before the bar breaks). A coupling member fixedly attached to the mouse is releasably attached by co-operable ball at an end of the bar and receiving socket in the coupling member (or vice versa). The bar is slidably engaged in and moves within a cavity inside the supporting device, to allow the bar, and hence an attached mouse, to slide relative thereto in use. Suitable means are provided, for example in the form of a detent, to ensure that the bar does not slide fully out of the socket in use.

Any suitable configuration of elongate coupling member may be used. A flexible elongate coupling member may be a rope, tape, string, chain or the lice. A rigid slidable coupling member may be a telescoping or otherwise relatively slidable arrangement of rods and/or bars and the like. The coupling member may be of fixed length. Alternatively, the coupling member may be adjustable length. For example, the coupling member may be slidingly engaged within the support device, means being provided to enable the user to selectively fix the length thereof to a desired length before use.

It is the nature of the small scale work which the coupling member is designed to facilitate that to and fro movement is more important than lateral movement. Accordingly, a flexible elongate coupling member is preferably of such material and/or construction as to permit more ready movement to and fro than laterally between the support device and a mouse coupled thereto. For example, this may be achieved by using an elastomeric material which is stiffened in a given direction, or by using material which has inherent anisotropy. In an alternative embodiment, a flat, elongate chain link arrangement is provided which has links so assembled as to permit curvature out of the plane of the flat elongate arrangement (and thus permit to and fro movement) but to limit curvature in the plane of the flat elongate arrangement (and thus side to side movement). Such chain arrangements will be familiar to the skilled person, for example in use as watch straps.

In an alternative embodiment, for use as a wrist support, a device in accordance with the invention is provided with means to attach the device to the subject's hand or arm. For example, a releasable strap is provided to pass over the dorsal side of a subjects hand or arm and this retains the support device in position on a palmar side thereof. Alternatively, an elastomeric sleeve is provided to similarly retain the support device.

Such an arrangement may also assist typists, serving as a support for the hands, in particular when not typing. The device also supports the hand and wrist during mouse use. It will be appreciated that if the device is only used in relation to a keyboard user who only rests the hands when not typing, then a low friction surface is not required since the device will not in use slide transversely along a work surface.

Although attaching the device to the user's hand may be inconvenient in some circumstances, even this device remains considerably less cumbersome and inconvenient than the glove devices suggested in the prior art.

In accordance with a further aspect of the invention, there is provided a kit of parts for provision of a hand and wrist support device for use in conjunction with a computer mouse, comprising the hand and wrist support device as above described, and means to engage the device in position upon a computer mouse. Preferably, the means to engage the device in the position upon the mouse comprise a releasable engagement means and flexible coupling means as above described. In a preferred embodiment, the flexible coupling means has at a first end a fixing to attach to a mouse or support device, for example a self-adhesive portion, and has at a second end a first fixing element configured to releasably engage with a separate second fixing element, which second fixing element is provided with a fixing means to fixedly attach to the other of mouse or support device, for example self-adhesively. In particular, the releasable attachment means comprising the two fixing elements is for simplicity a mutually co-operable felt pad and resilient hook fixing.

In accordance with a further aspect of the invention there is provided the use a device as hereinbefore described as a comfort aid to a user of a computer keyboard, mouse or the like and in particular of a computer mouse, and/or as a prophylactic device for the prevention of carpal tunnel syndrome and median nerve compression syndrome, and/or as a therapeutic device for the treatment of carpal tunnel syndrome and median nerve compression syndrome arising from excessive computer use.

The invention as now described by way of example and with reference to the accompanying drawings in which:

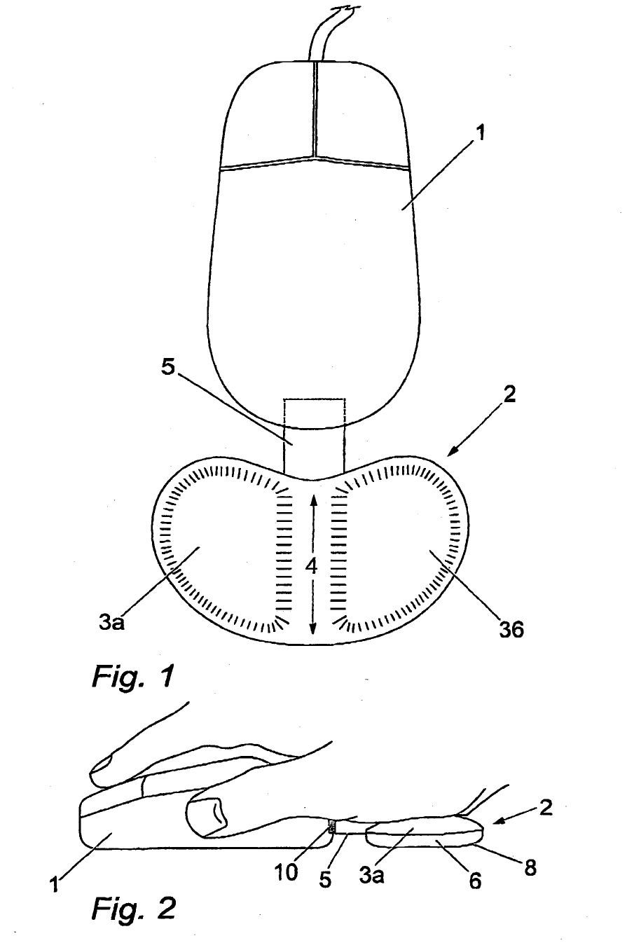

FIG. 1 is a plan view of a hand and wrist support in accordance with an embodiment of the present invention attached to a computer mouse;

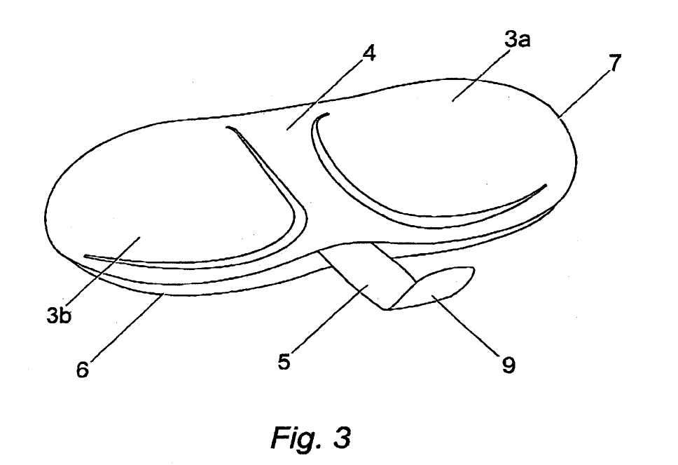

FIG. 2 is a side elevation of the embodiment of the invention and computer mouse of FIG. 1 in use;

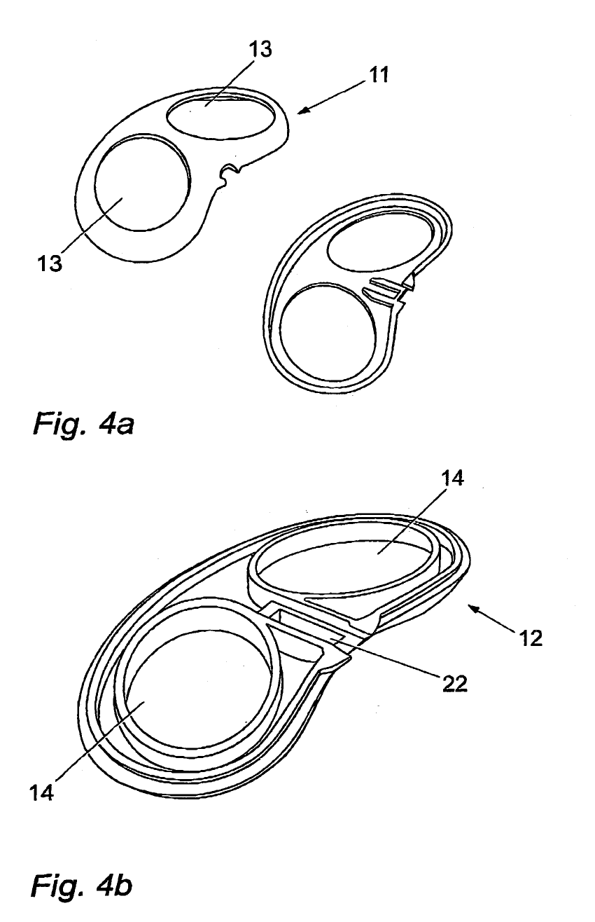

FIG. 3 is a perspective view of an embodiment of the invention;

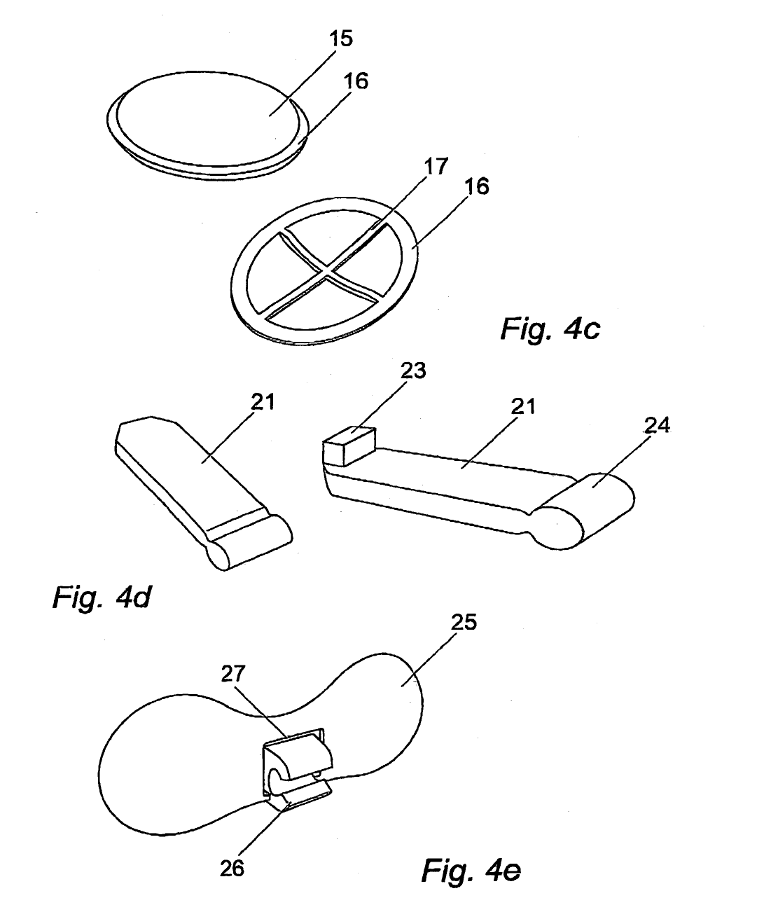

FIGS. 4a to 4e together male up an exploded view of an alternative embodiment of the invention;

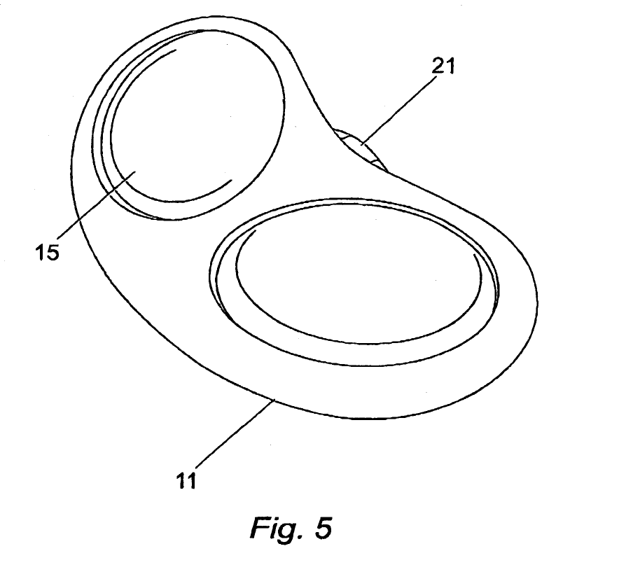

FIG. 5 represents a perspective view of the embodiment of FIG. 4 when assembled.

Referring to FIG. 1, a conventional computer mouse (1) is shown attached to a support in accordance with the invention (2). An upper support layer is visible which defines two raised areas (3a, 3b) defining a gap therebetween (4). The support (2) is attached to the mouse (1) by means of the tape (5) which is flexible enough to allow some small scale relative movement, and particular to and fro relative movement, between the mouse (1) and support (2) in use.

The device is shown in use by a right handed user in FIG. 2, and further detail is provided by the perspective view of FIG. 3. In use, the user supports the thenar area at the proximal end of the thumb on the first pad (3a) and the corresponding area of soft tissue at the other side of the carpal tunnel at the joint of the fourth metacarpal and the carpals on the other pad (3b). The hand is supported with the wrist held straight, and with the carpal tunnel area lying over, and the median nerve running parallel to, the gap (4). In this position, comfort for the user is increased for two reasons. First, the wrist is maintained in a straight configuration, which is acknowledged to be important in preventing or alleviating many symptoms of repetitive strain injury associated with excessive mouse and keyboard use. Second, all of the downward pressure on the hand or arm is reacted by the support surface 3a and 3b, such that there is no direct pressure applied to the carpal tunnel area. It will be appreciated that although a right-handed user is shown in the example, the device is readily interchangeable for left handed use.

The upper support means made up of the raised areas (3a, 3b) is mounted on a base (6). The raised areas (3a, 3b) are flexibly resilient foam, such as open cell polyurethane foam, which is optionally covered by a protective and/or anti-static coating. The base is a single piece moulding of low friction acetal, which is found in use to provide sufficiently reduced friction at the lower surface to allow adequate translational motion of the device (2) in conjunction with the mouse (1). The base (6) has a domed lower surface (8) with rounded outer edges. This facilitates movement of the device in use over minor irregularities, and in particular on and off the edge of a mouse mat or similar.

The coupling tape (5) is slidingly engaged within the device (2) to allow for adjustment of length. Prior to use, the user slides the tape (5) backwards and forwards to a desired length, and then fixes in this position. The device (2) is then attached to the mouse (1) by means of mutually co-operable surfaces consisting of mutually engageable tabs of felt loop and resilient hook (9, 10).

In the embodiment of FIG. 3, a vinyl cover (7) is provided to top the raised areas (3a and 3b). Application of a covering material has advantages in that the cover can be made easy to clean, have anti-static properties or the like. Additionally, the cover may be felt to improve the aesthetics of the device, and may for example be printed with images, logos or the like. The commercial value of being able to do his will be appreciated by analogy with the incorporation of similar images, logos or the like on the upper surface of mouse mats.

The cover (7) is highly flexible, and thus depresses readily when the hand is supported so that it exerts negligible pressure on the carpal tunnel area and the median nerve. However, the material has sufficient resilience to spring back once the hand is removed.

FIGS. 4 and 5 illustrate an alternative embodiment of the invention. The embodiment is shown fully assembled in FIG. 5, and different components are show disassembled in FIGS. 4a to 4e.

As FIGS. 4a and 4b illustrate, the base member of this embodiment of support device comprises a two piece moulding, with a base portion (12) (FIG. 4b) and upper portion (11) (FIG. 4a) fabricated from acetal. FIGS. 4a and 4b illustrate pre-fabrication mouldings, which are designed for sonic welding, and therefore include flanges for this purpose. In the alternative, provision of snap fit connections or other suitable means to engage the two portions (1), (12) could be envisaged. In the alternative, the base portion, upper portion and flexible domes could be manufactured as a complete item using an injection moulding process known as over-moulding.

Referring to FIG. 4a, it can be seen that the upper part (11) includes apertures (13). Corresponding housings (14) are provided in the lower part of (12). These are to receive the support members of FIG. 4c. In FIG. 4c, a flexible dome of elastomeric material (15) is provided with a flange (16) and support ribs (17) to give a degree of rigidity. In use, this is placed within the housing to protrude through the aperture before the two halves of the base member are assembled. This provides the flexibly resilient support for the heel of the hand. The flexible domes may include a variety of surface textures designed to reduce the surface area in contact with the skin of the user with the aim of reducing trapped perspiration and increasing comfort.

A suitable connector is shown in FIGS. 4d and 4e. A sliding rod (21) is slidingly received within a recess (22) in the base portion. A detent (23) prevents it from sliding fully out. A connector (25) shown in FIG. 4e attaches fixedly to the mouse by any suitable means. A ball and socket type joint is achieved between rod (21) and connector (25), with a cylinder (24) at the end of the rod (21) engaging with a snap fit receiving socket (26). Thus, a small amount of relative to and fro motion of the support and a mouse to which it is attached is enabled. The socket (26) is provided with a slot (27) which allows it to flex to some degree.

FIG. 5 illustrates the whole thing assembled. In this case, the housing is not shown, and the sliding member is fully retained within the support member. In this configuration, the support can be used without being directly connected to the mouse.

1. A hand and wrist support for a user of a computer keyboard, mouse or the like comprises a body member having associated with an upper surface an upper support means to engage the user's hand or wrist in use which upper support means comprises at least a pair of raised areas defining a central channel therebetween.

2. A hand and wrist support in accordance with claim 1 wherein a pair of raised elements or a paired series of raised elements are provided, constituting a pair of raised areas disposed to define a linear channel therebetween.

3. A hand and wrist support in accordance with claim 1 or claim 2 wherein the raised areas are so configured that in use one raised area is able to support the soft tissue at the base of the thumb and in particular the thenar muscles and the other raised area is able to support the hand at the joint of the fourth metacarpal and the carpals, such that the raised areas define a trough area that runs parallel with the line of a user's median nerve in use.

4. A hand and wrist support in accordance with any preceding claim comprising a body member manufactured of a substantially rigid material, and an upper surface, or at least a raised element thereon, manufactured from a material exhibiting a degree of flexible resilience.

5. A hand and wrist support in accordance with claim 4 wherein the base member comprises a rigid base portion and a rigid top portion, said rigid top portion provided with holes through which flexibly resilient material protrudes to make up the raised elements.

6. A hand and wrist support in accordance with any preceding claim wherein the raised areas constitute generally hollow domes of elastomeric material.

7. A hand and wrist support in accordance with claim 6 wherein the generally hollow domes are provided internally with structured support ribs for extra rigidity.

8. A hand and wrist support in accordance with any preceding claim wherein the body member has associated with a lower surface thereof means to reduce translational friction, to facilitate slidable movement of the device for use in association with a computer mouse.

9. A hand and wrist support in accordance with claim 8 wherein the base element comprises a wheel, roller, ball or other rotational means.

10. A hand and wrist support in accordance with claim 8 wherein the means to reduce translational friction comprises a low function surface.

11. A hand and wrist support in accordance with claim 10 wherein the low friction surface is integral with at least the lower part of the base member in the sense that at least the lower part of the base member is fabricated from a lower friction material.

12. A hand and wrist support in accordance with claim 11 wherein the base member is fabricated from acetal.

13. A hand and wrist support in accordance with any preceding claim further comprising mounting means to couple the supporting device with a computer mouse.

14. A hand and wrist support in accordance with claim 13 wherein the mounting means are adapted to couple the supporting device to the mouse in use in such manner as to permit limited relative movement between the support and the mouse when coupled.

15. A hand and wrist support in accordance with claim 14 wherein the mounting means incorporate one or more relatively slidable portions to facilitate such relative movement.

16. A hand and wrist support in accordance with claim 15 wherein the mounting means comprises a rigid bar slidingly received in a cavity in the support device and attachable to the mouse by a releasable snap fit connector.

17. The device in accordance with any one of claims 1 to 12 for use as a wrist support and further comprising means to attach the device to the hand or arm of a subject and retain the device in position on a palmar side thereof.

18. The use of a device in accordance with any one of claims 1 to 16 as a comfort aid to a user of a computer, and/or as a prophylactic device for the prevention of carpal tunnel syndrome and median nerve compression syndrome, and/or as a therapeutic device for the treatment of carpal tunnel syndrome and median nerve compression syndrome arising from excessive computer use.
